(19) United States
(12) Patent Application Publication
(10) Pub. No.: US 2011/0123947 A1
(43) Pub. Date: May 26, 2011

(54) DENTAL IMPLANT COMPRISING A MALE CONICAL CONNECTOR

(75) Inventors: Jean-Francois Borel, Chamalieres (FR); Yves Douillard, Chamalieres (FR); Phillippe Duchatelard, Chamallieres (FR); Jean-Philippe Picon, Lyon (FR); Romeo Casimiro, Saint-Genis-Laval (FR)

(73) Assignee: Tekka, Brignais (FR)

(21) Appl. No.: 12/740,797

(22) PCT Filed: Oct. 31, 2008
(86) PCT No.: PCT/FR08/01541

§ 371 Date: Feb. 7, 2011

(30) Foreign Application Priority Data
Oct. 31, 2007 (FR) 0758734

(51) Int. Cl. A61C 13/225

(52) U.S. Cl. 433/172

(57) ABSTRACT

The invention relates to a dental implant comprising an intraosseous anchoring base (1) provided with means for connecting to a support pillar (2) for a prosthetic tooth, said connecting means comprising a neck (11) provided with an annular groove (10) extending upwardly by a tenon (12). Said implant is characterised in that the tenon (12), which has a conical profile, is capped in a tight manner by a homothetic borehole (20) made in the base (21) of the pillar, and carries an indexing relief (13) that can co-operate with a complementary impression in the borehole of the pillar in order to ensure the angular positioning thereof.

The present invention relates to a dental implant comprising a male frustoconical connector.

The present invention relates more particularly to the means for connecting together the anchorage implant body of the implant and the supporting post of the prosthetic tooth.

Various implant bodies comprising specific means for connection to a supporting post already exist.

EP 0 075 525 discloses a dental implant comprising a neck, having an annular groove, which is continued in the upward direction by a male part for connection to a prosthetic tooth (false stump).

However, these implants can become the site of infections which occur usually at the interface between the bone region of the implant and the gingiva. The origin of these infections is bacterial growth in the connection means which are inadequately sealed.

It is an object of the present invention to overcome this first technical problem by moving the prosthetic connection above this region and improving the seal of the joint between the male part and the post in order to prevent the proliferation of germs.

Incidentally, it would appear that known implants also generate concentrations of excessive bone stresses, leading to the risk of osteopenia and/or fibrosis.

Another object of the present invention is to solve this technical problem by modifying the profile of the implant in the parts situated at the embedded limit of the implant body.

Lastly, known implants do not allow rapid wound healing of the gingiva in the implant region, or satisfactory stability of the gingival tissue.

It is therefore also an object of the invention to optimize the profile of the neck defining the space where the gingiva is reconstructed in such a way as to ensure better contact between the scar tissue and the implant.

In order to solve the technical problems outlined above, the implant of the present invention is characterized in that said male part, which has a frustoconical profile, is designed to be surmounted in a sealed manner by a homothetic bore formed in said post and carries an indexing relief capable of engaging with a mating impression formed in the bore of said post to define its angular position.

In accordance with an advantageous feature, said groove has a curvature defined by at least two distinct radii in such a way as to optimize the space necessary for gingival reconstruction.

In accordance with another feature, the shortest diameter of said neck is midway along its length.

In accordance with yet another feature, the outward end of the implant body has a rounded peripheral edge of approximately 1 mm radius joining it to the base of said neck.

The base of said post is preferably frustoconical.

In accordance with an advantageous feature, said indexing relief takes the form of an equilateral triangular-section nose inscribed within the upper face of the male part.

In accordance with yet another feature, said male part has a tapped axial passage whose lower end is situated approximately halfway along the length of the neck and which is designed to accommodate a screw passing along the bore.

In one particular embodiment, the shortest diameter of the neck is 2.7 mm and its height 1.5 mm.

In another embodiment, the upper diameter of the male part is 3.5 mm.

In yet another embodiment, the two radii of curvature of the neck are each between 0.5 and 2.5 mm.

The implant of the invention significantly reduces the risk of bacterial infection because of the improved grip and seal of the cone-to-cone joint between the implant body and the post.

Moreover, the specific profile of the connecting neck is particularly atraumatic and helps to accelerate gingival wound healing activity.

Another advantage lies in the specific profile of the indexing means.

A clearer understanding of the invention will be gained from reading the description, given below purely by way of explanation, of one embodiment of the invention, with reference to the appended figures, in which:

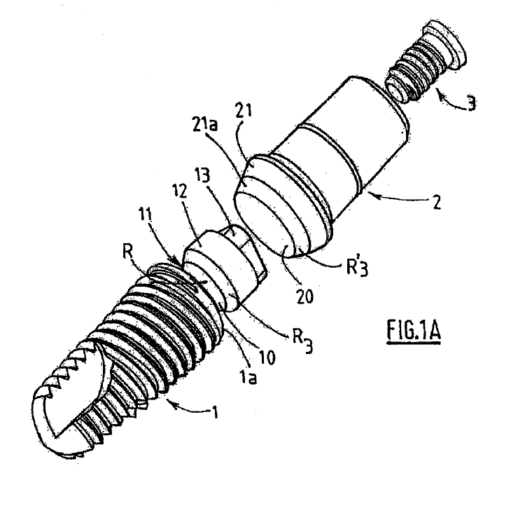

FIGS. 1A and 1B are exploded perspective views of an embodiment of the implant of the invention;

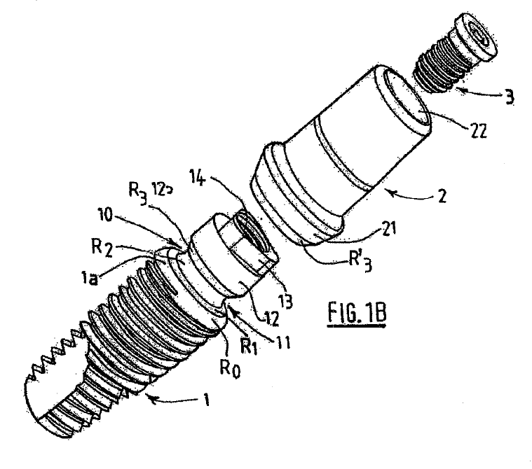

FIG. 2 is a partial view of the implant body seen in FIG. 1;

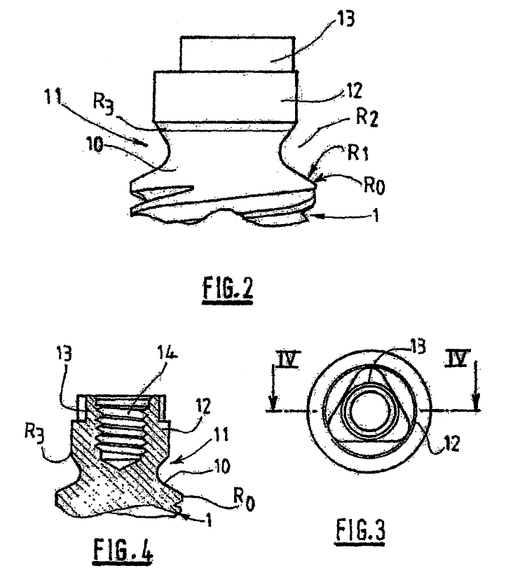

FIG. 3 is a top view of the implant body seen in FIG. 2; and

FIG. 4 is a view in partial cross section on IV-IV through the implant body seen in FIG. 3.

The implant according to the invention, as illustrated in FIGS. 1A and 1B, comprises a threaded implant body 1 for endosseous anchorage.

The implant body 1 has connection means at its outward end 1a for connection to a supporting post 2 for a prosthetic tooth (not shown). These connection means comprise a neck 11, having an annular groove 10, which is continued in the upward direction by a male part 12.

The male part 12, which has a frustoconical profile that becomes narrower in the upward direction, is designed to be surmounted in a sealed manner by a homothetic bore 20 formed in the base 21 of the post 2.

The male part 12 carries an indexing relief 13 which can engage with a mating impression (not visible in the figures) formed in the closed end of the bore 20 of the post 2 to define its angular position.

The groove 10 has a curvature which is determined by at least two distinct radii R1, R2 so as to optimize the space required for gingival reconstruction.

The shortest diameter of the neck 11 is located approximately half way along its length.

The end 1a of the implant body 1 which remains on the outside of the bony tissue has a rounded peripheral edge whose radius R0 is approximately 1 mm, which provides the connection to the base of the neck 11 and offers continuity of profile with the radius of curvature R1 of the groove 10 (see FIG. 2).

The indexing relief here takes the form of an equilateral triangular-section nose 13 inscribed within the upper face of the male part 12.

The apices of the triangular nose 13 are rounded to facilitate fitting the post 2.

The male part 12 has a tapped axial passage 14 whose lower end is located approximately halfway along the length of the neck 11 and which is designed to accommodate a screw 3 for locking the post 2 to the implant body 1.

The screw 3 is housed in a well 22 communicating with the bore 20 and through the mating impression of the indexing relief 13 on the male part 12.

The base 21 of the post 2 is also frustoconical but its cone is inverted compared with that forming the male part 12.

To increase the strength and seal of the assembly, the invention provides for the lower edge 21a of the base 21 of the post 2 to be given a slight curvature of radius R′3 homothetic to the curvature R3 located, on the implant body 1, at the junction between the neck 11 and the male part 12.

The joint is thus completely sealed and prevents the entry of any organic particles that could cause bacteriological contamination.

The implant body 1 is preferably anchored by screwing it into the bony tissue.

If required, the upper part of the implant body will be provided with drive means such as peripheral recesses to provide a purchase for a tightening tool.

When the post 2 is being fitted to the implant body 1, the lateral face of the male part 12 provides translational guidance to the base 21, followed by a complementary rotation for the mutual engagement, at the end of the assembly procedure, of the impression and the indexing relief.

The engagement between the relief 13 and the impression also prevents rotation of the prosthetic tooth.

Occluded air can escape to the exterior through the well 22.

In a preferred embodiment, the shortest diameter of the neck 11 is 2.7 mm and its height is 1.5 mm; the upper diameter of the male part 12 is 3.5 mm; and the two radii of curvature (R1, R2) of the neck 11 are each between 0.5 and 2.5 mm.

The cone angle of the male part 12 and the cavity 20 is between 4° and 6°.

The invention is described above by way of example. It will be understood that a person skilled in the art will be capable of producing variants of the invention without thereby departing from the scope of the patent.

1. A dental implant of the type comprising an endosseous anchorage implant body (1) provided with connection means for connection to a supporting post (2) for a prosthetic tooth, said connection means comprising a neck (11) having an annular groove (10), which is continued in the upward direction by a male part (12), said implant being characterized in that said male part (12), which has a frustoconical profile, is designed to be surmounted in a sealed manner by a homothetic bore (20) formed in the base (21) of said post and carries an indexing relief (13) capable of engaging with a mating impression formed in the bore of said post to define its angular position.

2. The implant as claimed in claim 1, characterized in that said groove (10) has a curvature defined by at least two distinct radii (R1, R2) in such a way as to optimize the space necessary for gingival reconstruction.

3. The implant as claimed in claim 1, characterized in that the shortest diameter of said neck (10) is midway along its length.

4. The implant as claimed in claim 3, characterized in that the outward end (1a) of the implant body (1) has a rounded peripheral edge of approximately 1 mm radius (R0) joining it to the base of said neck.

5. The implant as claimed in claim 1, characterized in that the upper diameter of the male part (12) is 3.5 mm.

6. The implant as claimed in claim 1, characterized in that the two radii of curvature (R1, R2) of the neck (11) are each between 0.5 and 2.5 mm.

7. The implant as claimed in claim 1, characterized in that said indexing relief (13) takes the form of an equilateral triangular-section nose inscribed within the upper face of the male part (12).

8. The implant as claimed in claim 1, characterized in that said male part (12) has a tapped axial passage (14) whose lower end is situated approximately halfway along the length of the neck (11) and which is designed to accommodate a screw (3) passing along the bore (20).

9. The implant as claimed in claim 1, characterized in that the shortest diameter of the neck (11) is 2.7 mm and its height 1.5 mm.

10. The implant as claimed in claim 1, characterized in that the base (21) of said post (2) is frustoconical.
